(19) United States
(12) Patent Application Publication
(10) Pub. No.: US 2008/0294655 A1
(43) Pub. Date: Nov. 27, 2008

(54) METHOD AND APPARATUS FOR GENERATION OF A USER PROFILE

(75) Inventors: Jerome Picault, Paris (FR); Myriam Ribiere, Nozay (FR)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/753,828

(22) Filed: May 25, 2007

(51) Int. Cl. G06F 17/30

(52) U.S. Cl. 707/100; 707/E17.109

(57) ABSTRACT

The invention relates to generation of a user profile for applications and/or services such as e.g. recommendation of content items. Initially, a first user profile is generated at a first user device for a first user. The first user device furthermore stores user contacts for the first user with the user contacts being associated with a social network of the first user. A set of user devices associated with a set of user contacts of the stored user contacts is then determined and at least part of the first user profile is transmitted to this set of user devices. At least one user device generates user profile feedback which is transmitted back to the first user device. The first user device then modifies the first user profile in response to the received user profile feedback. The invention may allow a fast generation of an initial user profile with improved accuracy.

### FIELD OF THE INVENTION

The invention relates to a method and apparatus for generation of a user profile and in particular, but not exclusively, to generation of a user profile for content item recommendation.

### BACKGROUND OF THE INVENTION

In recent years, an increasing number of services and applications with many different options and customisation features have become available to the user.

For example, the availability and provision of multimedia and entertainment content has increased substantially and in order to identify and select the desired content, the user must typically process large amounts of information which can be very cumbersome and impractical. Therefore, personalised content recommendation services and applications are becoming increasingly popular and significant resources have been invested in research into techniques and algorithms that may assist in identifying suitable content.

However, in order for personalised and user customised services to operate efficiently, it is critical that a reliable user profile is captured for the individual user. Many personalisation applications include functionality for continuously adapting and updating the user profile based on the users operations and selections. However, generation of an accurate initial user profile tends to be difficult.

One way to generate an initial user profile for a personalisation system is by observation (unsupervised learning). In such systems, the creation of a user profile is based on first observing the user's behaviour over time. While such systems do not require any explicit interaction with the user and can adapt to changes in the user's interests over time, they do require a training period and therefore initial user profile generation takes some time. In order to generate an accurate user profile the training period is typically relatively long thereby introducing a substantial delay in the personalisation performance.

Another approach to generate a user profile is to request the user to explicitly provide feedback on specific examples. E.g. the user can be requested to provide explicit feedback on examples of relevant information, such as sample content items. The personalisation system then processes the feedback according to internal weighting rules and builds a user profile. Although this process is simple, the examples may not be representative and typically a large number of examples are required to achieve an accurate user profile resulting in a cumbersome process for the user.

Thus, in many personalisation systems, the generation of an initial user profile is achieved by users initially being required to manually initiate the user profile, for example by explicitly entering personalisation data. This approach may for example require the user to respond to questionnaires, to rate sample item examples, etc.

However, although such an approach may be a suitable way of initiating a user profile it relies on the user being able to accurately describe his profile (e.g. preferences or characteristics). However, it has been demonstrated that self-description tends to be very subjective and relatively inaccurate (Ref. e.g.: Block, J., & Funder, D.C. (1986). Social roles and social perception: Individual differences in attribution and “verror.” Journal of Personality and Social Psychology, 51, 1200-1207.)

Specifically, self profiling typically suffers from an often involuntary self-induced bias. For example, users often describe themselves as they would like to be rather than as they really are. Such cognitive biases may for example include:
Choice-supportive bias: the tendency to remember one's choices as better than they actually were. This may tend to overestimate some user preferences.
Selective perception: the tendency for expectations to affect perception (For instance, several studies have shown that students who were told they were consuming alcoholic beverages (which in fact were non-alcoholic) perceived themselves as being “drunk”, exhibited fewer physiological symptoms of social stress, and drove a simulated car similarly to other subjects who had actually consumed alcohol).
Primacy/recency effect: The primacy effect, in psychology and sociology, is a cognitive bias that results from disproportionate salience of initial stimuli or observations. If, for example, a subject reads a sufficiently long list of words, he or she is more likely to remember words read toward the beginning than words read in the middle. The inverse of this effect is the recency effect.
False memory is a memory of an event that did not happen or is a distortion of an event that did occur as determined by externally corroborated facts. In user modelling, this may result in “inventing” preferences the user does not really have.
Psychological repression: Unwilled banishment of disturbing wishes, thoughts or experiences from conscious awareness. This may result in the “removal” in the user profile of some preferences that are unwillingly considered as bad by the user.

Also, in addition to the self-induced bias, system-induced bias may also be introduced to the user profile. For example, when a user provides user profile data by filling out a form/questionnaire, several issues may arise:
Inaccuracy of the registration information. In many cases there is insufficient knowledge about the domain to reliably establish the user profile.
In addition, the degree of description of a preference is limited by the structure of the knowledge used to express this preference (e.g. expressing an interest about a specific football team may not be supported by the knowledge structure).

As a result, current approaches tend to be suboptimal and specifically tend to lead to (initial) user profiles which are inaccurate and/or cumbersome to generate.

Hence, an improved system for generating a user profile would be advantageous and in particular a system allowing increased flexibility, reduced complexity, facilitated operation/implementation, improved accuracy and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided a method of generating a user profile, the method comprising: generating a first user profile at a first user device for a first user; storing user contacts for the first user in the first user device, the user contacts being associated with a social network of the first user; determining a set of user devices associated with a set of user contacts of the stored user contacts; transmitting at least part of the first user profile to the set of user devices; receiving user profile feedback from at least a second user device of the set of user devices; and modifying the first user profile in response to the user profile feedback.

The invention may provide an improved generation of a user profile. In particular, an improved accuracy of a user profile can be achieved without requiring any guided or unguided learning based on the user behaviour. A reduced bias can be achieved for a user profile and in particular a reduced subjective bias can be achieved for a user profile generated from a manual user input by the user.

The social network may be a network comprising user devices associated with the user contacts of the first user and the user devices associated with user contacts of other users which are part of the network. The social network may be a network comprising a set of user devices associated with users that are linked as user contacts of at least one other user in the network.

The social network may be a network structure corresponding to a non-directed graph in which nodes are user devices of other users and with edges representing a physical communication means between the two user devices corresponding to the nodes connected by the edge. User devices are adjacent (i.e. nodes sharing a common edge) to the first user device if they are part of the user contacts of the first user. A user device is part of the social network of the first user if there exists a communication path in the graph (which may rely on a combination of possible heterogeneous communication means) between the user device and the user device of the first user.

According to another aspect of the invention there is provided an apparatus for generating a user profile, the apparatus comprising: means for generating a first user profile at a first user device for a first user; means for storing user contacts for the first user in the first user device, the user contacts being associated with a social network of the first user; means for determining a set of user devices associated with a set of user contacts of the stored user contacts; means for transmitting at least part of the first user profile to the set of user devices; means for receiving user profile feedback from at least a second user device of the set of user devices; and means for modifying the first user profile in response to the user profile feedback.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a network of user devices in accordance with some embodiments of the invention;

FIG. 2 illustrates an example of a user device in accordance with some embodiments of the invention;

FIG. 3 illustrates an example of a flowchart of a method of generating a user profile in accordance with some embodiments of the invention; and

FIG. 4 illustrates an example of a flowchart of a method of generating user profile feedback in accordance with some embodiments of the invention.

### DETAILED DESCRIPTION OF SOME EMBODIMENTS OF THE INVENTION

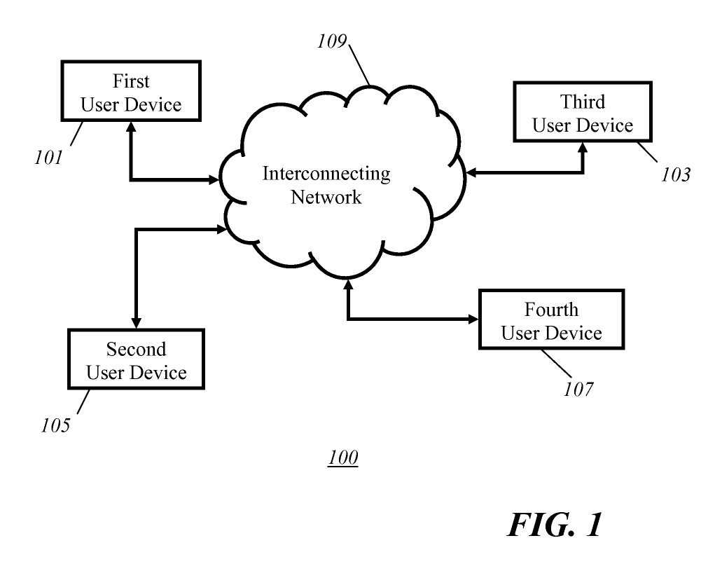

FIG. 1 illustrates a network of user devices in accordance with some embodiments of the invention. In the example, a plurality of user devices 101-107 are coupled to an interconnecting network 109 allowing the user devices 101-107 to communicate with each other.

Each of the user devices 101-107 may be any functional entity or group of entities capable of communicating with one or more of the other user devices 101-107. In the example, the user devices are furthermore capable of providing a personalised service or application to users of the user devices 101-107. The interconnecting network may be any network allowing the user devices 101-107 to communicate with each other. For example, the interconnecting network may be a network including a cellular communication system (such as GSM or UMTS), a Wireless Local Area Network (WLAN—such as e.g. IEEE 802.11a/b/c/n), the Internet etc or may e.g. partially or fully consist of direct communications between two user devices 101-107 without any intermediate equipment (for example the network may be an ad-hoc network based on dynamic and temporary communication links directly between user devices 101-107). The user devices 101-107 may e.g. be (portable) computers, mobile phones, Portable Digital Assistants (PDAs) and may specifically comprise a plurality of individual elements coupled together (such as e.g. a processing unit remotely coupled to a communication unit).

In the system of FIG. 1, the first user device 101 comprises functionality for generating a user profile. In the example, the user profile is used to adapt an application running on the first user device 101 to the specific preferences of the user. The application is specifically a content recommendation application that can recommend content items such as music items, video clips, newspaper articles, television programmes etc to the user. It will be appreciated that in other embodiments, the user profile may be used by external applications such as a centralised application providing a service to a plurality of user devices.

In the system, a user profile is first generated manually by the user of the first user device 101. However, rather than directly using the manually generated user profile as an initial user profile, the user profile is first distributed to a number of other selected user devices. This distribution is based on interrelations between user devices 101-107 as reflected e.g. in the address books of the individual user devices. Thus, the user profile is distributed to a network of users which are likely to have knowledge of the user's preferences and/or characteristics thereby allowing these users to provide feedback on the perceived accuracy of the user profile. The feedback data is transmitted back to the first user device 101 where it is used to modify the user profile before it is used by the recommendation application.

The system may thus provide a network of interrelated user devices that allow the information contained in social networks to be extracted and collected at the first user device 101 in order to correct a possible bias in the user profile self description. The approach thus extracts the knowledge contained in the user's social network and uses this to bootstrap, validate or refine the user profile.

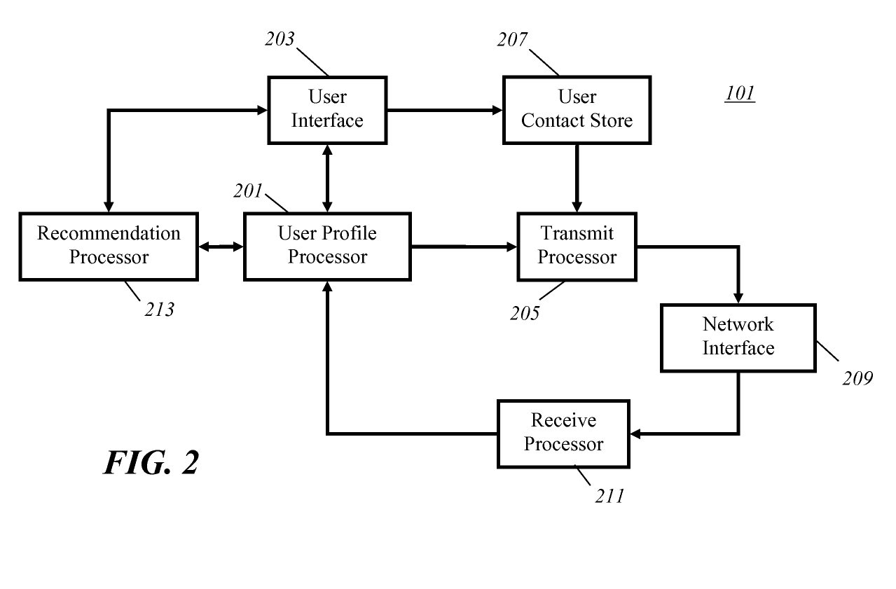

FIG. 2 illustrates an example of the first user device 101 in more detail. The first user device 101 comprises a user profile processor 201 which generates, maintains and modifies a user profile for the user of the first user device 101. The user profile processor 201 is coupled to a user interface 203 which is operable to present information to the user via e.g. a visual display and/or a loudspeaker and to receive manual user input from the user, e.g. via a keyboard.

The user profile processor 201 is further coupled to a transmit processor 205 which is further coupled to a user contact store 207 and a network interface 209. The transmit processor 205 is operable to receive user profile data from the user profile processor 201 and can generate messages comprising this data. It can furthermore retrieve user contact information from the user contacts in order to address the messages to the user devices associated with the selected user contact(s). The transmit processor 205 can then transmit the message to the appropriate user devices 103-107 via the network interface 209. It will be appreciated that the nature of the messages and the functionality of the network interface 209 will depend on the specific inter-user device communication techniques used in the specific embodiment. For example, the network interface 209 may comprise cellular communication functionality, (Wireless) Local Area Network ((W)LAN) communication functionality and/or Internet access technology.

The first user device 101 furthermore comprises a receive processor 211 which is coupled to the network interface 209 and the user profile processor 201. The receive processor 211 is arranged to receive feedback messages from other user devices 103-107 via the communication functionality of the network interface 209. The receive processor 211 extracts the user profile feedback data from the received messages and feeds this to the user profile processor 201.

The first user device 101 furthermore comprises a recommendation processor 213 coupled to the user profile processor 201 and the user interface 203. The recommendation processor 213 uses user preference data comprised in the user profile to identify and recommend content items to the user (via the user interface 203). It will be appreciated that there are many different algorithms and techniques for identifying content items suitable for a specific user based on a user preference profile known to the skilled person.

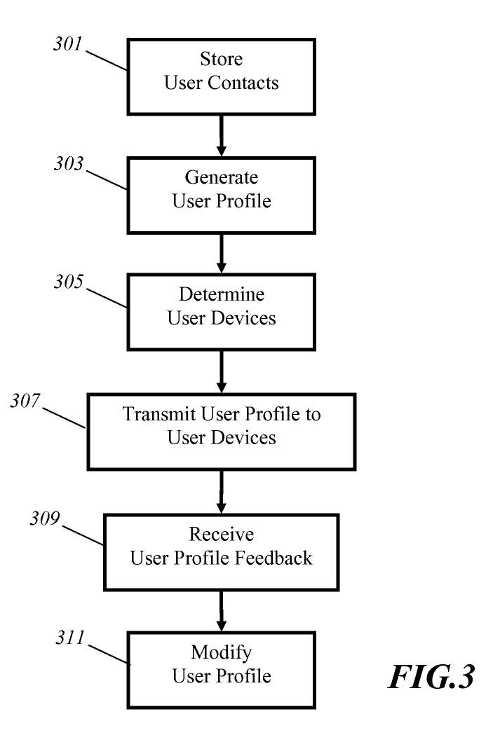

The operation of the first user device 101 when generating a new user profile will in the following be described in more detail with reference to FIG. 3 which illustrates a method of generating a user profile in accordance with some embodiments of the invention.

The method initiates in step 301 wherein user contacts are stored in the user contact store 207. The user contacts may be entered manually by the user using the user interface 203 and in addition the user may enter a communication address for the user device belonging to the user contact. Also, the user may input various data associated with the user contact such as specific user characteristics or an indication of the relationship to the user of the first user device 101 (e.g. friend, family, business contact etc). As a specific example, the user contacts may be stored in a phone book/address book of a mobile phone user device. The stored data can include the phone number of the mobile phone of each user contact.

The stored user contacts are part of a social network of the user of the first user device 101. The network comprises the user devices/user contacts stored in the address book as well as potentially a number of user contacts of the first user's user contacts. Thus, the social network may comprise several layers of user contacts including e.g. friends of friends etc. The social network may specifically be represented as a non-directed graph in which nodes correspond to user devices of other users. An edge between graph nodes of the social network represents a physical communication means between the two user devices corresponding to the nodes as well as the type of relationship existing between two users. In such a social network graph, the first user device 101 can for example select a sub-graph which corresponds to a particular type of relationship to the user (e.g. family, business, friends etc). The first user profile can then be propagated to all members of the sub-graph via the communication links that are represented by the edges of the sub-graph.

Step 301 is followed by step 303 wherein the user profile processor 201 generates a first user profile. The first user profile is generated based on information provided by the user manually inputting data which defines various self-perceived aspects or properties of the user. Alternatively or additionally, the user profile may be based on predetermined properties such as predetermined user data describing characteristics of the user. However, the first profile is not based on any user behaviour monitoring or learning from a user's behaviour. This allows the user profile to be generated without the delay typically associated with such approaches.

In the specific example, the user defines his profile manually and thus an initial self description by the user provides explicit user profile data reflecting the user's perceived preferences.

Such explicit data may for example include:
Personality traits. The user may explicitly indicate which personality category out of a predetermined group of personality categories he belongs to (such as “Feeler” or “Thinker”).
Personal preferences for a dedicated application, such as content preferences for the content item recommendation application. The preferences can e.g. be described through a taxonomy/ontology or a set of keywords.

The input from the user can be obtained by presenting a series of questions with a predetermined set of possible answers and recording the user's responses. E.g. for the content item recommendation, a number of sample content items with known characteristics may be presented with the user providing an explicit rating of each.

Step 303 is followed by step 305 wherein the transmit processor 205 determines a set of user devices associated with a set of user contacts of the stored user contacts.

Specifically, the transmit processor 205 retrieves information of the user contacts from the user contact store 207 and selects a subset of these (in some scenarios the entire set of user contacts may be selected). The selection of the subset of user contacts may be made in response to a user input. For example, the user can manually select individual user contacts or groups of user contacts to which the user profile will be transmitted.

Alternatively or additionally, the selection of the subset of user contacts may be in response to a user characteristic associated with the user contacts. Specifically, the user contact store 207 can additionally comprise some data characterising the corresponding user and this information may be used to select whether the individual user is included in the subset or not. For example, known preference data for different user contacts may be stored in the user contact store 207 (such information can e.g. be obtained in a symmetric system where other user devices may also send initial user profiles to the first user device 101 for feedback). The stored preferences can then be compared to the preferences manually provided by the user and the user contact can be included in the subset if these are sufficiently close to meet a given similarity criterion.

As another example, the user characteristic may comprise an indication of a relationship between the first user and the first user contact. For example, each of the user contacts may be associated with a group from a set consisting of e.g. “Friend”, “Family”, “Business Contact”, “Other”. Depending on the application for which the user profile is intended, the user may then select to send the user profile to user devices of a specific group, e.g. to all user contacts in the category of “Friends” for a music recommendation application, to all user contacts in the category of “Business Contact” for a job recruitment application etc.

In the specific example, the user can thus select possible candidates in the first layer of the user's social network in a manual or semi-automated way (e.g. selection of a sub-group matching a criterion such as a property or a tag—e.g. “my friends”).

The data for the user devices 103-107 associated with the selected user contacts is then retrieved from the user contact store 207. For example, in an embodiment based on cellular communications, the cellular telephone number stored for each selected user contact is retrieved. It will be appreciated that in other embodiments, other means of identifying/addressing the selected user devices may be selected such as e.g. using an IP address or a local area network address.

Step 305 is followed by step 307 wherein the transmit processor 205 transmits at least part of the user profile to the selected set of user devices 103-107. The message is transmitted using the communication functionality of the network interface 209.

In some embodiments, the entire user profile is transmitted. However, in other embodiments or scenarios only a subset of the user profile is transmitted. This may reduce the communication resource usage and/or allow the feedback to be restricted to areas where the user is interested in such feedback. Specifically, it may allow the user to keep elements of his user profile private.

The selection of the user profile subset to transmit may be made manually by the user via the user interface 203. For example, a user interface can be implemented which allows the user to select specific user profile categories for which he is interested in receiving user profile feedback from other users in his social network. The user can for example request feedback relating to broad categories (such as personality traits or personal preferences) or more detailed categories used to focus the answer of possible respondents on a more specific area. For example, the user can select a node in a preference taxonomy/ontology used by the user profile and this can be transformed into a query for feedback about the selected topic (such as sub-concepts or related concepts of the selected node). For example, selecting “sports” may allow respondents to specify specific sports the user is known to like (e.g. “soccer”, “tennis”) or even teams or players, as well as related preferences (e.g. films about sport).

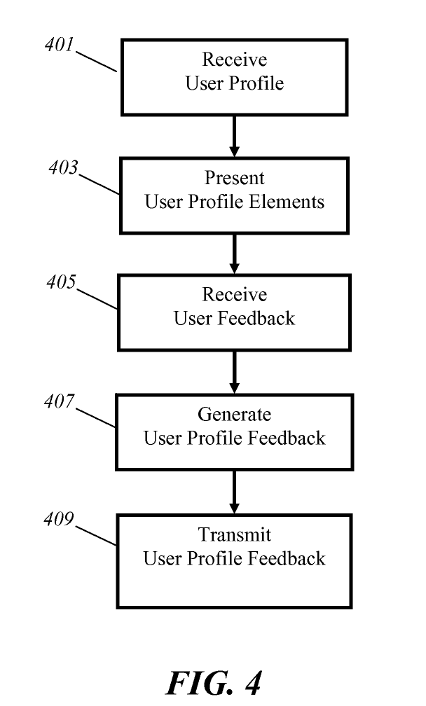

The messages comprising the user profile or part thereof are received by the user devices 103-107 to which they have been addressed. FIG. 4 illustrates an example of a flowchart illustrating the processing performed by one such user device, henceforth referred to as the second user device 103.

The method starts in step 401 wherein the user profile is received by the second user device 103. For example, the second user device 103 can receive messages transmitted using a cellular communication system and can extract the user profile data therefrom.

Step 401 is followed by step 403 wherein at least part of the user profile is presented to a user of the second user device 103. The second user device 103 may directly present user data from the user profile such as e.g. specific preferences for specific content, specific personality characteristics etc. Alternatively or additionally, the second user device 103 can present the user data indirectly. For example, query sentences can be generated from the user profile data and can be displayed on a visual display of the second user device 103.

Step 403 is followed by step 405 wherein the user of the second user device 103 provides a user feedback. For example, the user may respond to the query sentences, may provide user profile data for the first user as perceived by the user of the second user device 103 or may e.g. confirm the presented user profile data thereby validating the received user profile data.

Step 405 is followed by step 407 wherein the second user device 103 generates user profile feedback in response to the user feedback. The user profile feedback may for example directly be the user's responses or may be data generated from this, e.g. by combining a plurality of user inputs.

Step 407 is followed by step 409 wherein the user profile feedback is transmitted back to the first user device 101.

Thus, the second user device 103 is provided with user profile data for the first user and the second user may in response be presented with simple questions which the second user can answer thereby providing feedback on the user profile. Thus, the system provides a mechanism for requesting other users belonging to a social network of the first user to e.g. provide description data for the first user, to validate the first user's self description or to modify the first user's self description.

The presented request for feedback is preferably very simple to understand and answer (e.g. requiring not more than a few seconds for each query). The queries may be presented as a questionnaire with a sequence of questions, (such as e.g. “User X thinks he wants news about Z. Do you think this is appropriate to him”?)

In some embodiments, the second user device 103 may only provide user profile feedback for a subset of the user profile. Specifically, the second user device 103 can compare the received user profile with a local user profile for the second user and select the subset in response to this comparison. In particular, the second user device 103 can select to only provide user profile feedback data for areas of the user profile for which the two users have corresponding characteristics. For example, the second user device 103 can compare preference values for each topic category in the user profile and can include only the topics for which the preferences of the two users meet a suitable similarity criterion in the subset of user profile data for which the second user is asked for feedback. This may improve the provided feedback and may for example result in the feedback for a given category (say “soccer”) to be provided only by users which also have a preference/interest in this category.

In some embodiments, the subset of the first user profile can specifically be set to be empty if the comparison is indicative of the first user profile and the second user profile exceeding a difference criterion. Thus, if the profiles of the first and second users are sufficiently different, the second user device 103 will not provide any user profile feedback to the first user device 101. This may provide an improved accuracy of the user profile as feedback is only obtained from other users likely to have a good understanding of the first users characteristics.

The method of the first user device 101 continues in step 309 wherein it receives user profile feedback from at least the second user device 103. In the specific example, the first user device 101 receives user feedback messages from a plurality of user devices 103-107 and feeds these to the receive processor 211 where the user profile feedback data is extracted and fed to the user profile processor 201. It will be appreciated that the same or different communication means may be used for transmitting the user profile feedback messages from the other user devices 103-107 to the first user device 101 as was used to transmit the original user profile feedback request messages from the first user device 101 to the other user devices 103-107. In the example, a cellular communication system is used for communications in both directions.

Step 309 is followed by step 311 wherein the user profile processor 201 modifies the first user profile in response to the user profile feedback data.

It will be appreciated that any suitable algorithm or approach for modifying the user profile may be used without detracting from the invention. For example, for each category and/or preference value comprised in the user profile feedback the user profile processor 201 may evaluate all received feedback data and change the preference value depending on the feedback data. For example, for each feedback indicating a perception of a higher preference, the preference value may be increased by a small amount and for each feedback indicating a perception of a lower preference, the preference value may be decreased by a small amount.

In some scenarios, the user profile feedback can comprise an indication of a validation of at least part of the first user profile by another user. Such validation indications may be used to designate the user profile (or parts thereof) to be validated. Such a designation may for example be used to terminate the feedback procedure or may be used as a confirmation that the user profile is ready to be used for a given application. As another example, the validation indication may be used to determine whether to modify the user profile. For example, if more than a given proportion of feedback data for a specific topic corresponds to a validation indication, the preference data for that topic may not be changed regardless of the other feedback data.

In some examples, the user profile feedback may comprise at least part of a user profile for the user providing the feedback. For example, if the user profile data being presented to the user of the second user device 103 is found to be very similar to this user's own preferences, he may choose to include a corresponding section of his own user preference in the feedback data. When receiving this data, the user profile processor 201 may enhance the user profile for the first user by including the additional information (which specifically may provide more detailed preferences than captured initially by the first user). This may allow the first user to benefit from a learning process of the second user device 103.

As a specific example, if the user profile of the first user shows a very high preference for soccer and specifically for a specific soccer team, the second user also having a high preference for this soccer team may transmit the part of his user profile relating to this soccer team back to the first user device 101. This user profile data may for example include individual preferences for specific matches, players etc. The additional user preference data can then be added to the first user's user profile thereby providing a more detailed initial user profile.

It will be appreciated that the addition of user profile data from the second user's user profile can be manually selected by the second user or can be automatically or semi-automatically selected. For example, a similarity criterion for the relevant parts of the two user profiles can be evaluated and if the similarity criterion is met, the data of the second user profile can be transmitted to the first user device 101.

It will be appreciated that other factors and parameters may be taken into account by the user profile processor 201 when modifying the user profile. Specifically, the user profile processor 201 can take user characteristics of the users providing the user profile feedback into account.

Such user characteristics can include a consideration of e.g.
the social distance (e.g. whether the user is a direct user contact of the first user or whether there are intermediate user contacts);
a socio-demographical belonging of the user providing the feedback;
a user profile characteristic of the user providing the feedback (e.g. an indication of how similar the user profiles are to each other).

Also, the user profile processor 201 may take into account various indications of the probable accuracy of the received feedback.

Specifically, the modification of the first user profile can be in response to an indication of a proportion of user devices that have provided user profile feedback. E.g. if only a low proportion of user devices provide feedback, the resulting feedback data may be considered less reliable and accordingly the modification to the user profile may be less than if a higher proportion of feedback is received (e.g. the weighting of the feedback data may be dependent on the proportion of user devices providing feedback).

In some embodiments, such accuracy indicators may be presented to the first user allowing him to manually weigh the received feedback data (or select that it is ignored completely).

In the example, the social network of the first user is formed by appropriate user contacts as well as appropriate user contacts of other user contacts in the network. Thus, the user profile may be transmitted to a first level of user devices corresponding to the selected user contacts. Each of these user devices may further select another set of user contacts/devices and forward the user profile to the selected user devices. This process may be repeated leading to a distribution/propagation of the user profile in the social network. The distribution may for example be limited by a number of allowable forwardings of the user profile (e.g. 3-5 “hops” may be allowed in the network).

Each of the user devices receiving the user profile may provide user profile feedback and in some embodiments the user profile processor 201 takes into account the number of forwardings/hops that are associated with a given user device providing user profile feedback. For example, user profile feedback from a direct user contact of the first user may be weighted higher than user profile feedback that is received from another user which has only been reached via a plurality of forwardings/hops. This is likely to provide a higher accuracy of the user profile as the feedback data from users more likely to have a good knowledge of the first user is rated higher than data from users less likely to have such knowledge.

In some embodiments, the first user device 101 may support a presence service which provides presence indications for the user contacts. These presence indications may indicate whether individual user contacts are currently available or not available. Such presence services are for example used in many real time communication services, such as online chat services. In such embodiments, the transmit processor 205 can select the user devices to which to transmit the user profile in response to the presence indications. Specifically, the user profile may only be transmitted to user contacts for which the presence indication reflects that the users are currently available and able to respond.

In some embodiments, the user profile feedback is not transmitted directly to the first user device 101 but is rather transmitted to a feedback server. This feedback server can combine the received user profile feedback from a plurality of user devices to generate combined user profile feedback. This combined user profile feedback may then be transmitted to the first user device 101 and used to modify the user profile. The use of an intermediate server may for example allow the feedback data to be anonymous so that the first user cannot precisely know the source of specific user profile feedback. This may result in a more accurate user profile feedback as users providing such profile feedback are more likely to be honest if the feedback is anonymous.

In some embodiments, the system may furthermore provide an incentive for user contacts to provide feedback. Various incentive schemes are possible depending on the specific application.

For example, in some systems, the user devices 101-107 store content items which may be exchanged between the user devices 101-107. In such a system, an incentive mechanism can be provided by setting the access rights depending on whether the user device accessing a content item has provided any user profile feedback to the user device hosting the content item. For example, user devices which have responded with user profile feedback may be allowed access to some content items stored in the first user device 101. This access may be prohibited for user devices from which no user profile feedback has been received.

As another example, when the user profile is used for a particular application/service, an incentive reward can be directly related to that application/service. Specifically, if one of the user devices 103-107 uses a specific service, the service level for that service may be made dependent on whether the user device 103-107 has provided user profile feedback.

For example, for users which use a specific service, an upgrade of their subscription to the service or an access to an extra service may be provided if more than a certain number of user profile feedbacks have been transmitted to requesting user devices. As a specific example of an application/service providing access to television and video content, a user providing user profile feedback can be allowed access to new channels during a two month period or can receive two free video downloads.

Such a reward mechanism can e.g. be provided by a feedback server which also gathers the user profile feedback transmissions. As another example, the first user device 101 (and other user devices receiving user profile feedback) can upon receipt of user profile feedback transmit a message to a reward server. This message can indicate the source of the user profile feedback as well as potentially an indication of the quality/amount of user profile feedback. The reward server may then provide the reward to the appropriate user, e.g. by changing the service level of a given service used by this user.

It will be appreciated that the described system can provide a number of advantages. For example, it can mitigate the subjectivity of self-description thereby leading to improved accuracy of a user profile. Specifically, the approach can provide an “averaged” user profile which reflects more users' perception and therefore is likely to be more accurate. Also, the approach does not require any initial learning but can be based on only explicit descriptions. This may provide a much faster initial user profile that can be used for a number of applications.

The user benefits may e.g. be understood from the following examples of scenarios in which the system may be used.

### Use Case 1: Building a Profile for Job Offering Applications.

In the example the user profile mainly comprises explicit elements that help in filtering content. In the case of an application that is providing job offers to a user, the profile can include user competencies that are not always easy to define by the use himself. Using a social (professional) network can help someone extract his/her right competencies, to find the right job. Such a system can therefore be an alternative to career development coaching.

Use Case 2: Building a Profile for Matchmaking (Dating) applications.

Dating application can use user profiles to find the best match between two users. This profile is often acquired explicitly through a questionnaire that asks users to describe themselves. The described system could be used to acquire a perceived profile from a set of close friends and can assist in extracting the pertinent personality traits that best summarize the user.

It will be appreciated that in the user device of FIG. 2, the user profile processor 201 and/or the transmit processor 205 and/or the receive processor 211 and/or the recommendation processor 213 may for example be implemented as an executable routine implemented in a processing unit such as e.g. a micro-controller, a digital signal processor and/or a central processing unit. Specifically, the functionality of each processor may be implemented as one or more subroutines executed on the same processing unit. Specifically all processors illustrated in FIG. 2 may be implemented as different unique sets of programming instructions that are executed on one processor (or distributed over a plurality of processors), or can each (partly or fully) be electronic circuitry such as a custom large scale integrated circuit state machine (or part of one). As another example, the processors may be implemented partly or fully as neural networks and/or fuzzy computing

Also, it will be appreciated that the user contact store 207 may be implemented as a suitable memory element, such as solid state memory (ROM, RAM, Flash memory etc), magneto and/or optical storage devices (hard disk, optical disc etc).

Also, it will be appreciated that the network interface 209 may for example comprise a receiver for receiving a data communication from a remote source, such as a radio receiver or a network interface (e.g. an interface to a local area network or the Internet). Similarly, it will be appreciated that the network interface 209 may for example comprise a transmitter for transmitting a data communication to a remote source, such as a radio transmitter or a network interface (e.g. an interface to a local area network or the Internet).

It will also be appreciated that the user interface 203 may be any man-machine interface. The user interface 203 may specifically comprise a visual display and/or loudspeaker for presenting information to a user and a microphone, touch-screen, camera and/or keyboard for receiving input from a user.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A method of generating a user profile, the method comprising:
generating a first user profile at a first user device for a first user;
storing user contacts for the first user in the first user device, the user contacts being associated with a social network of the first user;
determining a set of user devices associated with a set of user contacts of the stored user contacts;
transmitting at least part of the first user profile to the set of user devices;
receiving user profile feedback from at least a second user device of the set of user devices; and
modifying the first user profile in response to the user profile feedback.

2. The method of claim 1 further comprising:
the second user device presenting at least part of the first user profile to a user of the second user device;
the second user device receiving a user feedback from the user of the second user device; and
the second user device generating user profile feedback in response to the user feedback.

3. The method of claim 1 further comprising:
the second user device determining a subset of the first user profile in response to a comparison between the first user profile and a second user profile being a user profile of a user of the second device; and
the second user device only generating user profile feedback for the subset of the first user profile.

4. The method of claim 3 wherein the subset of the first user profile is empty if the comparison is indicative of the first user profile and the second user profile meeting a difference criterion.

5. The method of claim 1 wherein the step of determining the set of user devices comprises determining the set of user devices in response to a user input.

6. The method of claim 1 further comprising the first user device receiving presence indications for at least some of the stored user contacts from a presence service, the presence indications being indicative of a current availability of the user contacts; and wherein the step of determining the set of user devices comprises determining the set of user devices in response to the presence indications.

7. The method of claim 1 further comprising the first user device storing user characteristics associated with at least some of the stored user contacts; and wherein the step of determining the set of user devices comprises determining the set of user devices in response to the user characteristics.

8. The method of claim 7 wherein a user characteristic of a first user contact includes an indication of a relationship between the first user and the first user contact.

9. The method of claim 1 further comprising the first user device selecting a subset of the first user profile in response to a user input; and wherein transmitting at least part of the first user profile to the set of user devices comprises transmitting only the subset of the first user profile.

10. The method of claim 1 further comprising at least some user devices receiving the first user profile forwarding the first user profile to other user devices associated with user contacts of the at least some user devices.

11. The method of claim 10 wherein the step of modifying comprises modifying the first user profile in response to user profile feedback from a third user device and in response to a number of times the first user profile has been forwarded to reach the third user device.

12. The method of claim 1 wherein the user profile feedback comprises an indication of a validation of at least part of the first user profile by a user of the second user device.

13. The method of claim 1 wherein user devices providing user profile feedback transmits the user profile feedback to a feedback server; and the method further comprises:
the feedback server generating combined user profile feedback by combining user profile feedback for the first user profile from a plurality of user devices; and
the feedback server transmitting the combined user profile feedback to the first user device.

14. The method of claim 1 further comprising:
the second user device generating user profile feedback comprising at least part of a second user profile, the second user profile being a user profile of a user of the second device.

15. The method of claim 1 wherein the step of modifying the first user profile further comprises modifying the first user profile in response to a user characteristic of a user of the second user device.

16. The method of claim 1 wherein the step of modifying the first user profile further comprises modifying the first user profile in response to an indication of a proportion of user devices receiving the first user profile that provides user profile feedback.

17. The method of claim 1 further comprising the steps of:
the first user device storing content items;
the first user device receiving a request for access to a content item from a requesting user device, the requesting user device being a user device having received the first user profile; and
the first user device determining an access right for the requesting user device to the content item in response to an indication of whether the requesting user device has provided user profile feedback for the first user profile.

18. The method of claim 1 comprising:
a server providing a service to at least one user device having received the first user profile; and
the server determining a service level for the at least one user device in response to an indication of whether the at least one user device has provided user profile feedback for the first user profile.

19. The method of claim 1 wherein the step of generating the first user profile comprises generating the first user profile based on at least one of a user input and predetermined properties.

20. An apparatus for generating a user profile, the apparatus comprising:
means for generating a first user profile at a first user device for a first user;
means for storing user contacts for the first user in the first user device, the user contacts being associated with a social network of the first user;
means for determining a set of user devices associated with a set of user contacts of the stored user contacts;
means for transmitting at least part of the first user profile to the set of user devices;
means for receiving user profile feedback from at least a second user device of the set of user devices; and
means for modifying the first user profile in response to the user profile feedback.
